(19) United States
(12) Patent Application Publication
(10) Pub. No.: US 2006/0095231 A1
(43) Pub. Date: May 4, 2006

(54) Plant diagnosis support system and plant diagnosis support method

(75) Inventors: Mitsuyoshi Okazaki, Tokorozawa-Shi (JP); Kazumichi Suzuki, Yokohama-Shi (JP); Mitsuru Kubota, Machida-Shi (JP); Shunzo Watanabe, Chiyoda-Ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/256,054

(22) Filed: Oct. 24, 2005

(30) Foreign Application Priority Data
Nov. 1, 2004 (JP) 2004-318506

(51) Int. Cl. G21C 17/00; G06F 11/00

(52) U.S. Cl. 702/183; 702/188

(57) ABSTRACT

A plant diagnosis support system includes at least one of facilities provided on a plant company side, at least one of operation data collecting devices collecting, processing, and storing operation data of the plant facility, and a plant supervision server configured to receive the operation data stored in the operation data collecting device through a locally closed communication network and to transmit/receive data to/from a diagnosis support service computer to remotely support diagnosis of the plant facility, connected through an external communication line, wherein the plant supervision server has a graph display function of performing display in the same display format as in the operation data collecting device.

### BACKGROUND OF THE INVENTION

1. Field of the Invention

The present invention relates to a system for diagnosis support of a plant and a method for diagnosis support thereof, the system and method supporting diagnosis of the plant.

2. Description of the Related Art

In a case where a remote supervision service provider provides a service of remotely supervising states of rotating machines, such as generators and turbines, in power plants or the like placed in many places, a dispersed remote supervision system capable of continuously diagnosing and supervising geographically-dispersed rotating machines is used. As an example of a plant diagnosis support system and a plant diagnosis support method using such a dispersed remote supervision system and supervision method, Japanese Unexamined Patent Application Publication No. 2002-152862 (Patent Document 1) has been known.

In the system described in Patent Document 1, an independent data collecting unit is attached to each of geographically-dispersed rotating machines and these data collecting units continuously collect data of the rotating machines. The data collecting units connect to a central supervising station through a communication link, such as the Internet or a telephone line, and can transmit collected data. Accordingly, the central supervising station can supervise trend parameters and a vibration amplitude spectrum.

This dispersed remote supervision system is regarded as a basic system for providing a service of remotely supervising states of rotating machines, such as generators and turbines, in geographically-dispersed power plants by a remote supervision service provider.

For example, when vibration differed from vibration on the normal operation condition (which will be referred to as abnormal vibration, hereinafter) occurs in a rotating machine of a power plant, a maintenance operator of the power plant transmits electronic data or an oscillogram indicating the vibration of the rotating machine and related process data to a diagnosis service provider by e-mail or facsimile using the dispersed remote supervision system, so as to request diagnosis. On the other hand, the diagnosis service provider receives the diagnosis request, analyzes the data to estimate a cause of the fault, and makes a comment on countermeasures to be taken.

In the known plant diagnosis support system, when a trouble occurs in a machine, a maintenance operator of the machine transmits process data such as the rotating speed, a state of load, a temperature, a pressure or the like, in a form of electronic data or an oscillogram, to a diagnosis service provider by e-mail or facsimile. Since the process data and the vibration tendency of the rotating machine indicates whether a state of the machine is normal or not, the diagnosis service provider diagnoses the troubled machine on the basis of the process data transmitted from the maintenance operator.

However, in the plant diagnosis support system, a used language, a data format, and an arranging method of collected data often vary in every rotating machine and a manner of reproducing and displaying transmitted data is not uniform. Therefore, much time is disadvantageously required to analyze and diagnose data.

Furthermore, necessary data often increases as analysis and diagnosis of data progress. Therefore, much time is disadvantageously required to find a solution by requesting transmission of data or by inspecting data by going to the power plant every time.

When a power generating company receives a remote supervision/diagnosis service for a plurality of plants or power generating facilities by using the known technique, the same number of commercial communication lines as that of the plants or power generating facilities are required. Therefore, the cost of the communication lines increases as the number of plants increases.

Further, when the Internet is used, countermeasures for ensuring security in data communication and against an external attack to a computer system (e.g., installment of a firewall) must be taken in each plant. This increases a maintenance cost in a power generating company that requests diagnosis of a plurality of plants.

### SUMMARY OF THE INVENTION

The present invention has been made in view of the aforementioned conventional circumstances and it is an object of the present invention to provide a plant diagnosis support system and a plant diagnosis support method capable of quickly analyzing data and diagnosing a plant in which abnormal phenomenon occurred by uniforming a display format between a plant company side and a diagnosis support service provider side in the event of plant facilities, apparatuses, devices, units or the like provided on the plant company side.

It is another object of the present invention to provide a plant diagnosis support system and a plant diagnosis support method to suppress an security required to transmit data collected by data collecting devices provided in respective plant apparatuses to a diagnosis support service provider by using external communication lines when the plant company receives a service of diagnosing an abnormal state of vibration and processing state of a rotating machine, which is an example of the plant apparatus, from the plant diagnosis support service provider.

The present invention provides, in a first aspect, a plant diagnosis support system including: at least one of operation data collecting devices collecting, processing, and storing operation data including high-speed data and process data, of a plant facility; and a plant supervision server configured to receive the operation data stored in the operation data collecting device through a locally closed communication network and to transmit/receive data to/from a diagnosis support service computer to remotely support diagnosis of the plant facility, connected through an external communication line, wherein the plant supervision server has a graph display function of performing display in a same display format as in the operation data collecting device.

The present invention provides, in another aspect, a plant diagnosis support method including the steps of: receiving an access right to access a website from which a user having the access right is allowed to browse and download plant diagnosis data from a plant company side through a communication network upon receiving a plant diagnosis request from the plant company side; accessing the plant company side by using the access right received in the access right reception step, selecting data required for plant diagnosis from the website to which the plant diagnosis data is uploaded, and downloading the selected data; and transmitting a diagnosis result generated on the basis of the plant diagnosis data downloaded in the plant diagnosis data download step to the plant company side.

The present invention provides, in further aspect, a plant diagnosis support method including the steps of: uploading plant diagnosis data to a website set up by a plant company side; and transmitting an access right for accessing the website from which a user having the access right is allowed to browse and download plant diagnosis data upon completion of receiving a notice of acceptance for diagnosis request transmitted from a diagnosis service provider side.

According to the plant diagnosis support system and the plant diagnosis support method of the present invention, by installing a diagnosis program into a plant supervision server, a diagnosis support service computer, a high-speed data collecting unit and a process data collecting unit in advance and executing the diagnosis program installed, plant diagnosis data and diagnosis result can be displayed in a uniform display format in each of the plant supervision server, the diagnosis support service computer, the high-speed data collecting unit and the process data collecting unit.

Therefore, a plant company can determine the diagnosis result of a plant facility by using a common index, whereas a diagnosis support service provider can provide an advice on the diagnosis result of the plant facility by using an index common to that of the plant company. Accordingly, analysis of data and diagnosis of an abnormal phenomenon can be quickly performed when a trouble occurs in a plant.

In addition, the present invention enables to suppress an increase in cost of adding communication lines and ensuring security required to transmit data collected by data collecting devices provided in respective plant facilities to a diagnosis support service provider by using external communication lines when a plant company receives a diagnosis support service from the diagnosis support service provider.

### BRIEF DESCRIPTION OF THE DRAWINGS

FIG. 1 shows an example of a block diagram illustrating an embodiment of the plant diagnosis support system according to the present invention;

FIG. 2 is a flow chart showing a sequence of transmitting to the diagnosis request data according to the present invention;

FIG. 3 shows an example of correlation diagrams, each indicating a relationship between the rotating speed in a dynamo-electric machine in the power generating device/unit and vibration data measured at its bearing portion;

FIG. 4 shows an example of vibration data uniformly displayed in a display unit of both power generating company side and diagnosis support service provider side in the plant diagnosis support system according to the present invention;

FIG. 4 is also an example of explanatory diagram illustrated in a polarograph, which shows a relationship between a vibration amplitude upon increasing the rotating speed and the phase at that time.

### DESCRIPTION OF THE PREFERRED EMBODIMENTS

Now, description will be made regarding an embodiment of the present invention with reference to the attached drawings.

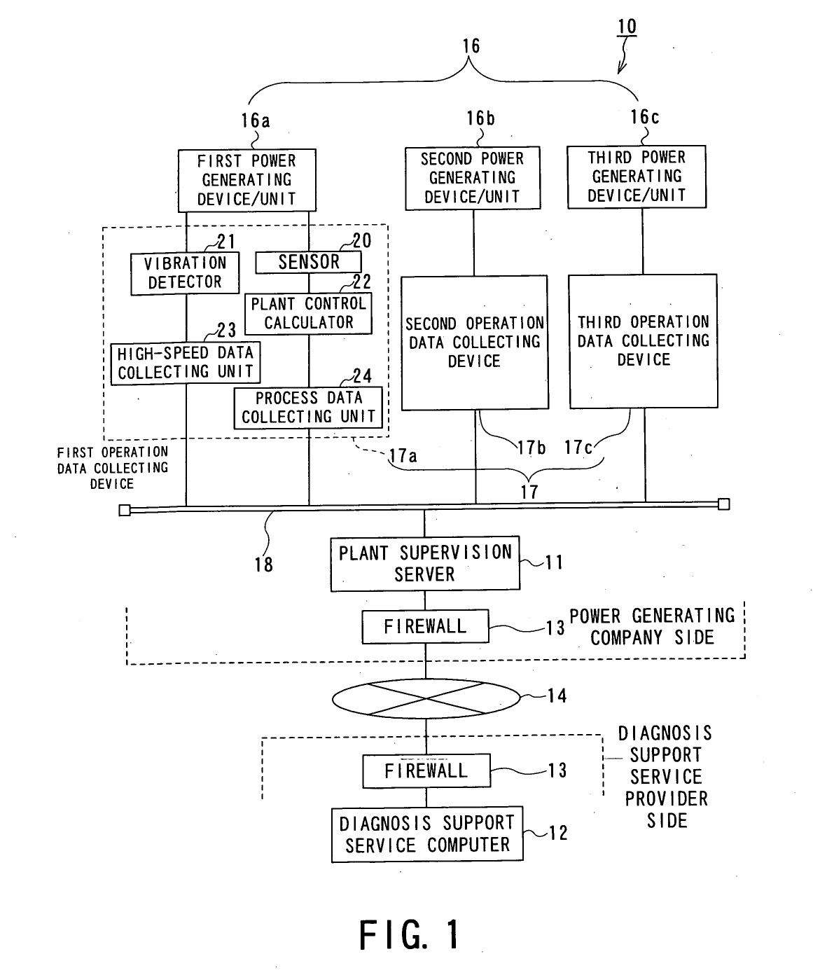

FIG. 1 shows a schematic configuration of a plant diagnosis support system 10 according to an embodiment of the present invention. Please note that a power plant so as to generate power shown in FIG. 1 is an example of a plant facility and a power generating company shown in FIG. 1 is an example of a plant company.

In FIG. 1, the plant diagnosis support system 10 is a system so as to preliminarily diagnose the power plant in which critical troubles may occur before detailed diagnosis thereof, and is configured to be capable of remotely performing diagnosis support of the power plant.

The plant diagnosis support system 10 includes a plant supervision server 11 provided on a side of the power generating company and a diagnosis support service computer 12 provided on a side of a company preliminarily diagnosing the power plant before detailed diagnosis thereof (which will be referred to as diagnosis support service provider, hereinafter), the plant supervision server 11 connecting to the diagnosis support service computer 12 through an Internet (communication network) 14 via firewalls 13. Further, in the plant diagnosis support system 10, information can be transmitted/received between the plant supervision server 11 (the power generating company side) and the diagnosis support service computer 12 (the diagnosis support service provider side).

The plant supervision server 11 provided on the power generating company side has a function of a Web server and is a device serving as a contact with an external company for the power generating company. More specifically, the plant supervision server 11 has a function of transmitting/receiving electronic information to/from an external device electrically connected through the Internet 14, a function of uploading/downloading data, a function of recording and storing electronic data, a function of inputting a request to the plant supervision server 11, and a function of performing an output process in response to an output request, such as a display request or a printing request.

Further, the plant supervision server 11 is configured to allow a user having an access right, that is, the diagnosis support service provider performing diagnosis, to freely browse specific data in response to a connection request therefrom. The plant supervision server 11 is also configured to allow the diagnosis support service provider to download browsable data.

The diagnosis support service computer 12 provided on the diagnosis support service provider side has a plant diagnosing function as well as a Web server function and is a device serving as a contact with an external company for the diagnosis support service provider. Herein, the plant diagnosing function includes a function of displaying operation data, a function of analyzing the operation data and diagnosing the state of a plant, and a function of allowing a diagnosis result to be browsable from the plant supervision server 11.

The firewall 13 is used to ensure security in order to prevent tapping or theft of data by a third party or invasion or attack to a computer in the event that the data is transmitted to an external device by using the Internet 14 serving as an external commercial communication network (external communication line). The firewall 13 adapts a VPN (Virtual Private Network) which is an example of a transmission method, or the like.

For example, in the event of using a diagnosis support service provided by a communication company, the VPN serving as the transmission method is typically used. Therefore, an increased number of access path to Internet 14 that can be used by the power generating company lead to an increased cost. For this reason, in the plant diagnosis support system 10, the contact with an external company on the power generating company side is limited to only one plant supervision server 11 so as to minimize the number of access path to Internet 14 required to transmit/receive data to/from an external company.

On the power generating company side of the plant diagnosis support system 10, the power generating company side has at least one of power plant which includes at least one of power generating apparatuses, devices, units, or the likes (which will be referred to as power generating device/unit, hereinafter) 16 serving as a plant facility and operates the power plant.

Further, the power generating company side of the plant diagnosis support system 10 includes, in addition to the plant supervision server 11, a operation data collecting device 17 collecting data indicating a state amount of the power generating device or unit as plant device or unit (which will be referred to as operation data, hereinafter).

In an example shown in FIG. 1, the power generating device/unit 16 includes at least one of, for example, three power generating device/units (first to third power generating device/unit) 16a, 16b and 16c. Further, The operation data collecting device 17 includes at least one of, for example, three operation data collecting devices (first to third operation data collecting device) 17a, 17b and 17c.

The operation data collecting devices 17a, 17b and 17c respectively connect to the plant supervision server 11 through an intranet 18 serving as a communication network such that the both sides can communicate with each other.

To connect the respective data collecting devices 17a, 17b and 17c with the plant supervision server 11 through an intra-company communication network such as the intranet 18 which is an example of a locally closed communication network is advantageous in that the communication fee and the cost for ensuring security are lower than a case of connecting the respective data collecting devices 17a, 17b and 17c with the plant supervision server 11 through an external commercial communication network, such as the Internet 14.

The operation data collecting devices 17a, 17b and 17c have essentially the same basic configuration although they collect operation data from different power generating devices or units, that is, the power generating device/units 16a, 16b and 16c respectively.

Therefore, an internal configuration of only the data collecting device 17a is shown in FIG. 1, and illustration and description of the other data collecting devices 17b and 17c are omitted. In addition, in the following description, each of the power generating device/units 16a to 16c and the data collecting devices 17a to 17c is referred to simply as a power generating device/unit 16 or a data collecting device 17 in the event that the respective power generating devices or units for collecting operation data need not be distinguished from each other.

The data collecting device 17 includes at least one of sensors 20 for sensing various process data, a vibration detector 21 for detecting a vibration data which is an example of a high-speed data, a plant control calculator 22, a high-speed data collecting unit 23, and a process data collecting unit 24. Now, the high-speed data is a data changing faster than the process data including a temperature, a degree of vacuum, an amount of generated power or the like.

The sensor 20 is attached to the power generating device/unit 16 and detects process data, such as a temperature, a degree of vacuum, and an amount of generated power of the power generating device/unit 16. The process data detected by the sensor 20, such as a temperature, a degree of vacuum, and an amount of generated power of the power generating device/unit 16, is transmitted from the sensor 20 to the plant control calculator 22.

The vibration detector 21 is attached to the power generating device/unit 16 as the sensor 20 and samples vibration data, which is an example of data changing faster than the process data including a temperature, a degree of vacuum, and an amount of generated power. The vibration data detected by the vibration detector 21 is transmitted from the vibration detector 21 to the high-speed data collecting unit 23.

The plant control calculator 22 is configured to supervise and control the process data sensed by the sensor 20, such as a temperature, a degree of vacuum, and an amount of generated power of the power generating device/unit 16. The plant control calculator 22 is also configured to select a piece of process data required to be collected from among pieces of process data to be supervised and controlled and to transmit the selected data to the process data collecting unit 24 which is electrically connected to the plant control calculator 22 and which is capable of transmitting/receiving electronic data.

The high-speed data collecting unit 23 is configured to collect high-speed data, such as the vibration data detected by the vibration detector 21. In the plant diagnosis support system 10 shown in FIG. 1, the high-speed data collecting unit 23 receives the vibration data from the vibration detector 21 so as to collect the vibration data.

Further, the high-speed data collecting unit 23 includes an input element for receiving a request from a user, a display element for displaying information which is requested to be displayed, a data recording element capable of recording and storing electronic data, and a communication element for transmitting/receiving data to/from an external device electrically connected to the intranet 18 (all of the units are not shown). With this configuration, the high-speed data collecting unit 23 is capable of storing collected vibration data in the data recording element, displaying the data in the display element, and transmitting the data to a connected external device through the intranet 18.

Furthermore, the high-speed data collecting unit 23 is capable of performing data processing as may be necessary upon recording and storing collected electronic data. For example, in the event that the collected data is vibration data (a vibration signal), the high-speed data collecting unit 23 is possible to store the vibration data in the electronic data recording element (not shown) by categorizing it into items: change in vibration amplitude (amplitude value); correlation between amplitude and phase of a rotational frequency component obtained by spectrum analysis and frequency analysis of the vibration signal; correlation between the rotating speed and amplitude/phase; transient waveform variation; and so on. Then, the high-speed data collecting unit 23 processes the high-speed data so as to form a suitable form of the high-speed data for each item.

The process data collecting unit 24 includes, as the high-speed data collecting unit 23, an input element for receiving a request from a user, a display element for displaying information requested to be displayed, a data recording element capable of recording and storing electronic data, and a communication element for transmitting/receiving data to/from an external device electrically connected to the intranet 18 (all of the units are not shown).

In the event that the process data collecting unit 24 receives a data collecting request input from the input element, the process data collecting unit 24 is possible to select a piece of process data corresponding to the data collecting request from among pieces of process data to be monitored and controlled by the plant control calculator 22. Then, the process data collecting unit 24 is possible to collect a piece of process data corresponding to the data collecting request from among pieces of process data to be monitored and controlled by the plant control calculator 22.

Further, the process data collecting unit 24 is capable of storing the collected process data in the data recording element, displaying the data in the display element, and transmitting the data to an electrically-connected external device through the intranet 18.

Please note that the plant supervision server 11, the high-speed data collecting unit 23, the process data collecting unit 24, and the diagnosis support service computer 12 are installed with a program for displaying a diagnosis result of a state of a plant (hereinafter referred to as plant diagnosis PG, not shown in FIG. 1), so that the plant supervision server 11, the high-speed data collecting unit 23, the process data collecting unit 24, and the diagnosis support service computer 12 are capable of displaying data in its own display element such as a monitor (not shown) by using a uniform display format.

In addition, since the plant supervision server 11, the high-speed data collecting unit 23, the process data collecting unit 24, and the diagnosis support service computer 12 are installed with the plant diagnosis PG, the plant supervision server 11 and the diagnosis support service computer 12 are capable of storing electronic data in the common data format so as to display in the same display format as in the operation data collecting device 17, more specifically, the high-speed data collecting unit 23 and the process data collecting unit 24.

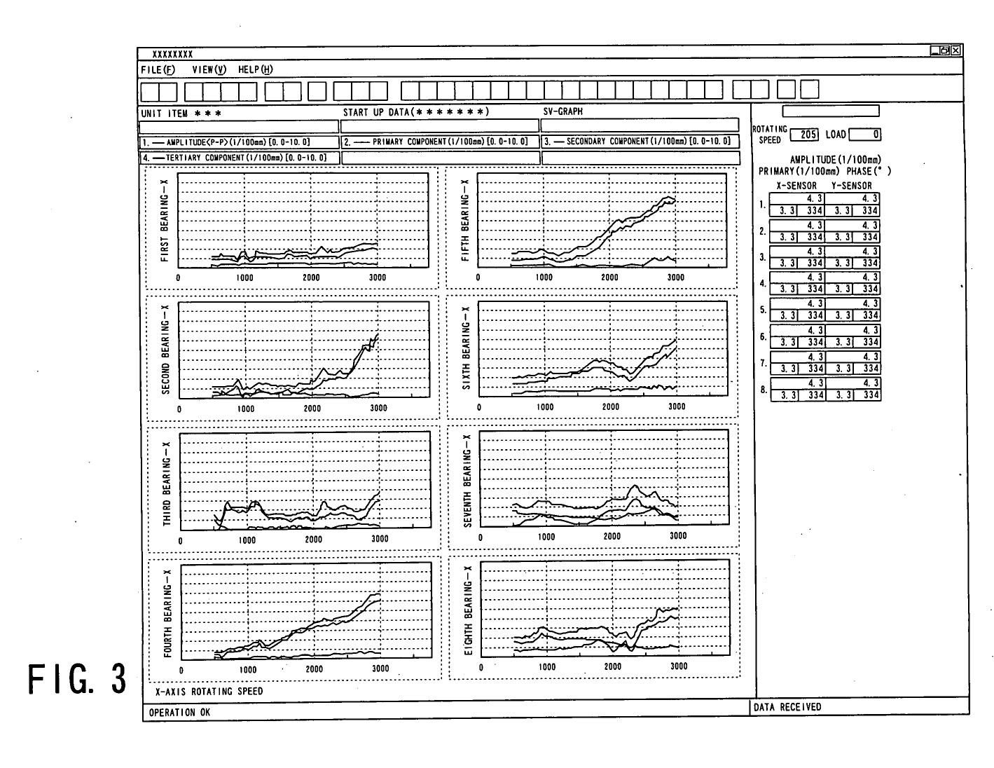

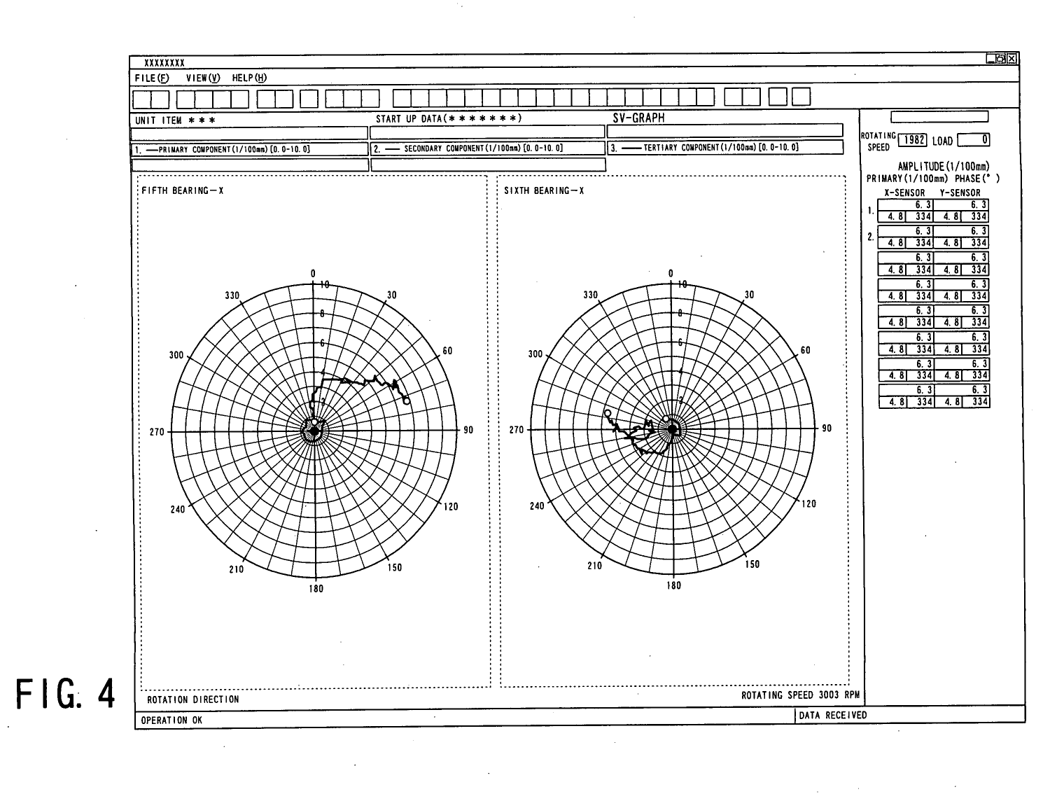

As a result, a data display format in the plant supervision server 11 and the diagnosis support service computer 12 is the same as that in the high-speed data collecting unit 23 as for high-speed data, and is the same as that in the process data collecting unit 24 as for process data. In other words, the plant supervision server 11 and the diagnosis support service computer 12 have a graph display function of displaying a diagnosis result in the manner shown in the graphs in FIGS. 3 and 4 (described later) using the same display format as that of the data collecting device 17.

While description has been made wherein the high-speed data collected and processed by the high-speed data collecting unit 23 is vibration data detected by the vibration detector 21 as shown in FIG. 1, the high-speed data collected and processed by the high-speed data collecting unit 23 may be other high-speed data detected by another detector. Examples of the high-speed data collected and processed by the high-speed data collecting unit 23 include a voltage waveform, a current waveform of an output from a generator and so on.

Further, while description has been made wherein the process data collecting unit 24 collects and processes the process data from the plant control calculator 22 as shown in FIG. 1, the process data collecting unit 24 may directly collect and process the process data from at least one of the sensors 20.

Furthermore, while description has been made wherein one power generating company operates the power plant which includes at least one of power generating device/units 16a to 16c, a plurality of power generating company may operate that.

In addition, not only one diagnosis support service computer 12 as shown FIG. 1 but also a plurality of the diagnosis support service computers 12 may be provided on the service provider side.

As described above, by constituting the plant diagnosis support system 10 such that the data received from the data collecting devices 17a to 17c is stored while the data format thereof is uniformed and by allowing the plant supervision server 11 to function as a contact between the power generating company and the diagnosis support service provider, the power generating company can uniform a used language, a data format, and an arranging method of operation data about the respective power generating device/units 16a to 16c. On the diagnosis support service provider side, time required by the diagnosis support service computer 12 for analyzing data and diagnosing a plant can be saved, and thus a cause of a state except for normal operation state (which will be referred to as abnormal state, hereinafter) can be speedily diagnosed.

By installing the plant diagnosis PG in the plant supervision server 11, the high-speed data collecting unit 23, and the process data collecting unit 24 in advance, the plant supervision server 11, the high-speed data collecting unit 23, and the process data collecting unit 24 can execute the PG to read data of a diagnosis result that needs to be displayed. Therefore, the plant supervision server 11 and the units 23 and 24 of the respective data collecting devices 17a to 17c can display the diagnosis result in a uniform display format.

Accordingly, the power generating company can determine diagnosis results of the power generating device/units 16a to 16c by using a common index. In addition, the diagnosis support service provider can provide an advice on the diagnosis results of the power generating device/units 16a to 16c by using an index common to that of the power generating company. That is, a request for diagnosing abnormality of a plant and analysis thereof can be efficiently performed.

In the event that a plurality of power generating device/units 16 are provided in the power generating company, the number of commercial communication lines required to transmit/receive information to/from the diagnosis support service computer 12 on the diagnosis support service provider side can be minimized by using the plant supervision server 11 as a contact with the diagnosis support service provider. As a result of minimizing the number of the plant supervision server 11 as a contact with the diagnosis support service provider, the plant diagnosis support system 10 can suppress an increase in cost caused by an increase in the number of power generating device/units 16.

Further, by using the plant supervision server 11 as a contact with the diagnosis support service provider, the number of apparatuses, devices, units or the like, required to ensure security can be minimized and a cost required to ensure security, such as a cost of installing firewalls, can be minimized. That is, an increase in cost caused by an increase in the number of power generating device/units 16 can be suppressed.

Next, a plant diagnosis support method according to the present invention is described.

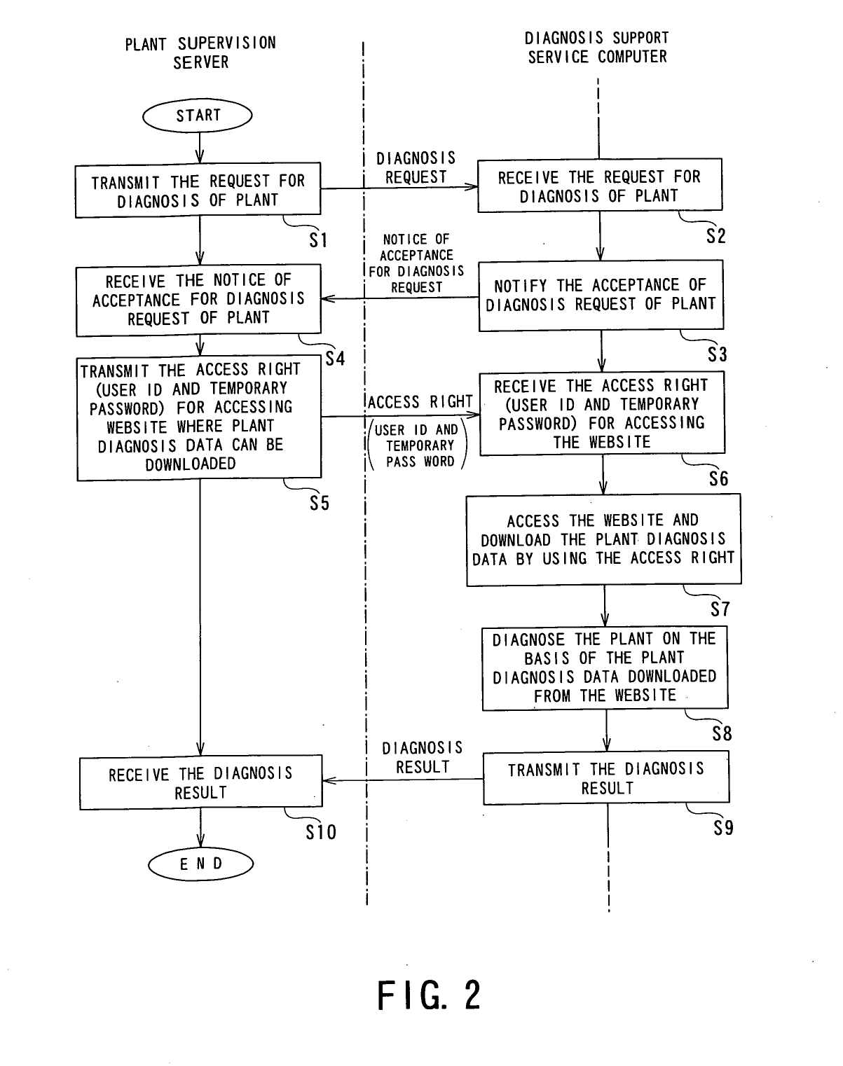

FIG. 2 illustrates a process performed by the power generating company and the diagnosis support service provider in the event that the power generating company requests a service of diagnosing the power generating device/unit 16 to the diagnosis support service provider.

Please note that the procedure shown in FIG. 2 is based on the premise which the diagnosis support service provider accepts a request for diagnosing the power generating device/unit 16 transmitted from the power generating company.

Further, in the procedure shown in FIG. 2, note that the diagnosis request means a request to preliminarily diagnose the power plant in which critical troubles may occur before detailed diagnosis thereof.

According to FIG. 2, the power generating company performs a diagnosis service request procedure and the diagnosis support service provider performs a plant diagnosis service procedure from transmission of a request for plant diagnosis service until reception of a diagnosis result. Please note that, before performing the diagnosis service request procedure, the power generating company needs to set up a website where data required for diagnosing a plant (which will be referred to as diagnosis data, hereinafter) can be browsed and obtained (downloaded) from the diagnosis support service provider side.

Further, the plant supervision server 11 performs a data centralized storing step in order to prepare diagnosis data whether some failures occur in the power plant or not. The plant supervision server 11 creates the diagnosis data based on data collected in the data centralized storing step and uploads the diagnosis data to a predetermined page of the set up website so as to prepare the diagnosis data (diagnosis data upload step).

Herein, the data centralized storing step is a step of collecting high-speed data and process data according to the respective power generating device/units 16a, 16b and 16c provided in the plant diagnosis support system 10 to the plant supervision server 11 and storing the data therein.

Under a state where the website for browsing and downloading diagnosis data from the diagnosis support service provider side is set up and the diagnosis data is prepared in the plant supervision server 11, in the event that the power generating company wants to request a diagnosis service of the power generating device/unit 16 to the diagnosis support service provider (START), the plant supervision server 11 executes a diagnosis request transmission step (Step S1).

In the diagnosis request transmission step (Step S1), upon receiving a request transmitting diagnosis request of the power generating device/units 16.

from a client, the plant supervision server 11 on the power generating company side transmits the diagnosis request to the diagnosis support service computer 12 on the diagnosis support service provider side by e-mail or the like. Upon completion of transmitting of the diagnosis request to the diagnosis support service provider side, the diagnosis request transmission step, i.e., Step S1 completes. Then, the procedure shown in FIG. 2 proceeds from Step S1 to Step S2.

In Step S2, the diagnosis support service computer 12 on the diagnosis support service provider side executes a diagnosis request reception step (Step S2) and receives the diagnosis request transmitted from the plant supervision server 11 on the power generating company side in Step S1.

Upon completion of receiving of the diagnosis request transmitted from the power generating company side, the diagnosis request reception step, i.e., Step S2 completes. Upon completion of Step S2, the procedure shown in FIG. 2 proceeds from Step S2 to Step S3.

In Step S3, the diagnosis support service computer 12 on the diagnosis support service provider side executes a diagnosis acceptance notice transmission step (Step S3) and transmits a notice of acceptance for diagnosis request received in Step S2 to the plant supervision server 11 on the power generating company side.

Upon completion of transmitting the notice of acceptance for diagnosis request received from the power generating company side in Step S2 to the power generating company side, the diagnosis acceptance notice transmission step, i.e., Step S3 completes. Then, the procedure shown in FIG. 2 proceeds from Step S3 to Step S4.

In Step S4, the plant supervision server 11 on the power generating company side executes a diagnosis acceptance notice reception step (Step S4) and receives the notice of acceptance for diagnosis request transmitted from the in Step S3 from.

Upon completion of receiving the notice of acceptance for diagnosis request transmitted from the diagnosis support service provider side, the diagnosis acceptance notice reception step, i.e., Step S4 completes. Then, the procedure shown in FIG. 2 proceeds from Step S4 to Step S5.

In Step S5, the plant supervision server 11 on the power generating company side executes an access right transmission step (Step S5) and transmits an access right (user ID and temporary password) for accessing a website where plant diagnosis data can be downloaded.

Upon completion of transmitting the access right to the diagnosis support service provider side, the access right transmission step, i.e., Step S5 completes. Then, the procedure shown in FIG. 2 proceeds from Step S5 to Step S6.

In Step S6, the diagnosis support service computer 12 on the diagnosis support service provider side executes an access right reception step (Step S6) and receives the access right including user ID and temporary password, transmitted from the plant supervision server 11 on the power generating company side.

Upon completion of receiving of the access right including user ID and temporary password from the power generating company side, the access right reception step, i.e., Step S6 completes. Then, the procedure shown in FIG. 2 proceeds from Step S6 to Step S7.

In Step S7, first, the diagnosis support service computer 12 on the diagnosis support service provider side accesses a predetermined page where the diagnosis data can be downloaded by using the access right received in Step S6. In the event of successfully accessing the predetermined page where the diagnosis data can be downloaded, the diagnosis support service computer 12 can browse the diagnosis data of the power generating device/unit 16 to be diagnosed.

In the browsed page, the diagnosis data is displayed in a predetermined display format, for example, change in vibration against time and change in vibration against the rotating speed. More specifically, the display format of high-speed data is the same as that in the high-speed data collecting unit 23 and the display format of process data is the same as that in the process data collecting unit 24.

Next, in the event that the diagnosis support service computer 12 browses the diagnosis data of the power generating device/unit 16 to be diagnosed, on the diagnosis support service provider side, the diagnosis data to be downloaded is checked and determined. When the diagnosis support service provider side determines data to be downloaded, the diagnosis support service computer 12 executes a plant diagnosis data download step.

Upon executing the plant diagnosis data download step (Step S7), the diagnosis support service computer 12 downloads the diagnosis data.

Upon completion of downloading the diagnosis data, the plant diagnosis data download step, i.e., Step S7 completes. Then, the procedure shown in FIG. 2 proceeds from Step S7 to Step S8.

In Step S8, the diagnosis support service computer 12 on the diagnosis support service provider side executes a power plant diagnosis step as a plant diagnosis step (Step S8).

Upon executing the power plant diagnosis step, the diagnosis support service computer 12 on the diagnosis support service provider side analyzes the abnormal phenomenon based on the downloaded (obtained) data and diagnoses the power plant in which the abnormal phenomenon occurs. Upon completion of generating a diagnosis result, the power plant diagnosis step, i.e., Step S8 completes. Then, the procedure shown in FIG. 2 proceeds from Step S8 to Step S9.

In Step S9, the diagnosis support service computer 12 on the diagnosis support service provider side executes the plant diagnosis result transmission step and transmits the diagnosis result to the plant supervision server 11 on the power generating company side by e-mail or the like. Upon completion of transmitting the diagnosis result to the power generating company side, the plant diagnosis result transmission step, i.e., Step S9 completes. Then, the procedure shown in FIG. 2 proceeds from Step S9 to Step S10.

In Step S10, the plant supervision server 11 executes the plant diagnosis result reception step and receives the diagnosis result from the diagnosis support service provider side. Upon completion of receiving the diagnosis result from the diagnosis support service provider side, the plant diagnosis result reception step, i.e., Step S10 completes.

When the plant diagnosis result reception step, i.e., Step S10 completes, a series of steps from requesting a plant diagnosis service to receiving a diagnosis result shown in FIG. 2 are completed.

While the diagnosis data upload step is executed before “START” in this embodiment, the diagnosis data upload step may be executed any time before Step S7.

Further, in Step S7, while the plant supervision server 11 in this embodiment is configured to allow to download the diagnosis data from the website where the diagnosis data can be downloaded upon successfully accessing the website, the plant supervision server 11 may be configured to allow to download the diagnosis data in the event of receiving information of correct access right.

Furthermore, in Step S9, while the diagnosis support service computer 12 on the diagnosis support service provider side transmits the diagnosis result to the plant supervision server 11 in this embodiment, another computer (not shown) provided on the diagnosis support service provider side may transmit the diagnosis result to the plant supervision server 11.

Next, a uniform display format used in common in the plant diagnosis support system 10 is described.

FIGS. 3 and 4 show examples of the uniform display format used in common in the plant diagnosis support system 10. Herein, vibration data is displayed as an example of the high-speed data.

FIG. 3 shows an example of correlation diagrams, each indicating a relationship between the rotating speed in a dynamo-electric machine (not shown) in the power generating device/unit 16 and vibration data measured at its bearing portion. In the correlation diagrams shown in FIG. 3, the horizontal axis indicates the rotating speed and the vertical axis indicates vibration data measured at the bearing portion. An amplitude, a rotation primary component, and a rotation secondary component are displayed in each diagram.

FIG. 4 shows an example of vibration data uniformly displayed in a display unit of both power generating company side and diagnosis support service provider side in the plant diagnosis support system according to the present invention. In this figure, vibration amplitude when the rotating speed increases and the phase at that time are illustrated in a polarograph.

In this way, since the plant diagnosis support system 10 is configured capable of displaying the plant diagnosis data in a predetermined display format, for example, change in vibration against time and change in vibration against the rotating speed on the respective elements or the like respectively prepared for displaying on the power generating company side and the diagnosis support service provider side, information related to an abnormal phenomenon can be shared by an operator and a maintenance staff of the power generating device/unit 16 and the diagnosis support service provider.

In other words, by providing the plant supervision server 11, the high-speed data collecting unit 23, and the process data collecting unit 24 that are capable of performing display in the predetermined scale and format shown in FIGS. 3 and 4, both the requesting side (the power generating company side) and the diagnosing side (the diagnosis support service provider side) can share information between the requesting side and the diagnosing side.

Further, since the information related to an abnormal phenomenon can be shared between the requesting side and the diagnosing side, the diagnosing side can recognize a characteristic of a phenomenon at an early stage and smoothly perform detailed diagnosis thereafter.

Furthermore, since the information related to an abnormal phenomenon can be shared between the requesting side and the diagnosing side, the diagnosing side can detect occurrence of abnormality and efficiently diagnose a power plant occurred the abnormal phenomenon.

According to the procedure shown in FIG. 2, on the requesting side, a plant diagnosis service requesting procedure performed by the power generating company includes a plant diagnosis data upload step (not shown in FIG. 2) of uploading diagnosis data of the plant and an access right transmission step of transmitting a right to access a page where the diagnosis data can be browsed and downloaded after diagnosis is requested and accepted.

On the other hand, the plant diagnosis service procedure performed by the diagnosis support service provider includes an access right reception step of receiving an access right to a page where diagnosis data can be browsed and downloaded after accepting a diagnosis request from the power generating company, a plant diagnosis data download step of downloading the diagnosis data, a diagnosing step of performing diagnosis by using the downloaded data, and a diagnosis result transmission step of transmitting (notifying) the power generating company of the diagnosis result.

As described above, according to the plant diagnosis support system 10, even if a plurality of power generating device/units 16 are provided on the power generating company side, the power generating company can uniform a used language, a data format, and an arranging method of operation data about the respective power generating device/units 16a to 16c by using the plant supervision server 11 for collecting and accumulating the operation data as a contact with the diagnosis support service provider. On the diagnosis support service provider side, time required by the diagnosis support service computer 12 for analyzing data and diagnosing a plant can be saved, and thus a cause of abnormality can be speedily diagnosed.

By installing the plant diagnosis PG in the plant supervision server 11, the high-speed data collecting unit 23, and the process data collecting unit 24 in advance, the plant supervision server 11, the high-speed data collecting unit 23, and the process data collecting unit 24 can execute the PG to read data of a diagnosis result that needs to be displayed. Therefore, the plant supervision server 11 and the units 23 and 24 of the respective data collecting devices 17a to 17c can display the diagnosis result in a uniform display format.

Accordingly, the power generating company can determine diagnosis results of the power generating device/units 16a to 16c by using a common index. In addition, the diagnosis support service provider can provide an advice on the diagnosis results of the power generating device/units 16a to 16c by using an index common to that of the power generating company. That is, a request for diagnosing abnormality of a plant and analysis thereof can be efficiently performed.

In the event that a plurality of power generating device/units 16 are provided in the power generating company, the number of commercial communication lines required to transmit/receive information to/from the diagnosis support service computer 12 on the diagnosis support service provider side can be minimized by using the plant supervision server 11 as a contact with the diagnosis support service provider. As a result of minimizing the number of the plant supervision server 11 as a contact with the diagnosis support service provider, the plant diagnosis support system 10 can suppress an increase in cost caused by an increase in the number of power generating device/units 16.

Further, by using the plant supervision server 11 as a contact with the diagnosis support service provider, the number of apparatuses, devices, units or the like, required to ensure security can be minimized and a cost required to ensure security, such as a cost of installing firewalls, can be minimized. That is, by reducing the number of external communication lines, such as the Internets 14, lines to be secured can be reduced. As a result of reducing the number of external communication lines, the plant diagnosis support system 10 contributes to cost reduction and enhances the quality of security due to the fewer lines and to ease the security ensuring upon transmitting/receiving information between the power generating company side (the plant supervision server 11) and the diagnosis support service provider side (the diagnosis support service computer 12).

Furthermore, since only the plant supervision server 11 contacts the diagnosis support service provider, necessary diagnosis data can be provided to the diagnosis support service provider while preventing invasion by a third party to the units 23 and 24 on the power generating company side and ensuring security.

What is claimed is:

1. A plant diagnosis support system comprising:
at least one of operation data collecting devices collecting, processing, and storing operation data including high-speed data and process data, of a plant facility; and
a plant supervision server configured to receive the operation data stored in the operation data collecting device through a locally closed communication network and to transmit/receive data to/from a diagnosis support service computer to remotely support diagnosis of the plant facility, connected through an external communication line,
wherein said plant supervision server has an element for performing display in a same display format as in the operation data collecting device.

2. The plant diagnosis support system according to claim 1, wherein said diagnosis support service computer has an element for performing display in the same display format as in the plant supervision server.

3. The plant diagnosis support system according to claim 1, wherein said plant supervision server is configured to store electronic data received from the operation data collecting device in a common data format so as to display in the same display format.

4. The plant diagnosis support system according to claim 1, wherein said plant supervision server is provided on a plant company side and is composed of only one computer allowed to transmit/receive data to/from a diagnosis support service computer, of all computers thereon.

5. The plant diagnosis support system according to claim 1, wherein said operation data collecting device includes at least one of a high-speed data collecting unit collecting high-speed data and a process data collecting unit collecting process data.

6. The plant diagnosis support system according to claim 5, wherein said high-speed data collecting unit, plant supervision server and diagnosis support service computer are respectively configured to display the graph related to high-speed data in the common display format.

7. The plant diagnosis support system according to claim 5, wherein said process data collecting unit, plant supervision server and diagnosis support service computer are respectively configured to display the graph related to process data in the common display format.

8. The plant diagnosis support system according to claim 5, wherein said high-speed data collecting device is configured to store the high-speed data including at least one of vibration data and of signal waveform data.

9. The plant diagnosis support system according to claim 5, wherein said high-speed data collecting device is configured to store the high-speed data including at least one of vibration data of a rotating machine and data of a voltage waveform and a current waveform of output from a generator.

10. The plant diagnosis support system according to claim 5, wherein said high-speed data collecting device is configured to store the high-speed data by categorizing the data into items including at least one of change in vibration amplitude, correlation between amplitude and phase of a frequency component obtained by spectrum analysis and frequency analysis of a vibration signal, correlation between the frequency and amplitude/phase, and a transient waveform variation.

11. The plant diagnosis support system according to claim 5, wherein said high-speed data collecting device is configured to store the high-speed data by categorizing the data into items including at least any of change in vibration amplitude, correlation between amplitude and phase of a rotational frequency component obtained by spectrum analysis and frequency analysis of a vibration signal, correlation between the rotating speed and amplitude/phase, and a transient waveform variation.

12. The plant diagnosis support system according to claim 1, wherein said plant supervision server is configured to transmit an access right including user ID and temporary password for accessing a website from which a user having the access right is allowed to download plant diagnosis data to diagnosis support service computer.

13. The plant diagnosis support system according to claim 12, wherein said plant supervision server is configured to allow to download the plant diagnosis data from the website in the event that the plant supervision server receives information of correct access right.

14. A plant diagnosis support method comprising the steps of:
receiving an access right to access a website from which a user having the access right is allowed to browse and download plant diagnosis data from a plant company side through a communication network upon receiving a plant diagnosis request from the plant company side;
accessing the plant company side by using the access right received in the access right reception step, selecting data required for plant diagnosis from the website to which the plant diagnosis data is uploaded, and downloading the selected data; and
transmitting a diagnosis result generated on the basis of the plant diagnosis data downloaded in the plant diagnosis data download step to the plant company side.

15. The plant diagnosis support method according to claim 14, wherein said plant diagnosis data and diagnosis result are displayed, in the common display format between the plant company side and the diagnosis support service provider side, on a monitor provided on each of the plant company side and the diagnosis support service provider side.

16. A plant diagnosis support method comprising the steps of:
uploading plant diagnosis data to a website set up by a plant company side; and
transmitting an access right for accessing the website from which a user having the access right is allowed to browse and download plant diagnosis data upon completion of receiving a notice of acceptance for diagnosis request transmitted from a diagnosis service provider side.

17. The plant diagnosis support method according to claim 16, wherein said plant diagnosis data and diagnosis result are displayed, in the common display format between the plant company side and the diagnosis support service provider side, on a monitor provided on each of the plant company side and the diagnosis support service provider side.
